(19) United States
(12) Patent Application Publication
(10) Pub. No.: US 2026/0081497 A1
(43) Pub. Date: Mar. 19, 2026

(54) SWITCHED RELUCTANCE MOTOR WITH ASYMMETRIC LOSS DISTRIBUTION

(71) Applicant: ENEDYM INC., Hamilton (CA)

(72) Inventors: Ehab Sayed, Hamilton (CA); Berker Bilgin, Hamilton (CA)

(21) Appl. No.: 19/332,278

(22) Filed: Sep. 18, 2025

Related U.S. Application Data
(60) Provisional application No. 63/696,548, filed on Sep. 19, 2024.

(51) Int. Cl. H02K 3/28; H02K 1/14; H02K 1/24

(52) U.S. Cl. CPC H02K 3/28; H02K 1/146; H02K 1/246

(57) ABSTRACT

A switched reluctance machine is described herein. The switched reluctance machine includes a rotor and a stator disposed concentrically with the rotor, the stator having stator teeth and windings wound about the teeth. The windings include, for each phase of the switched reluctance machine, a first set of coils and a second set of coils. The first set of coils includes first coils characterized by a first number of turns and the second set of coils includes second coils characterized by a second number of turns. The first number of turns is higher than the second number of turns. A motorized micro-mobility system that includes the switched reluctance machine is also described herein.

### FIELD OF THE INVENTION

The described embodiments relate generally to switched reluctance machines, and in particular, to a switched reluctance machine (SRM) having asymmetric loss distribution.

### BACKGROUND

Electric machines have been applied as motors and generators in a wide range of industries for more than a century. A reluctance machine is an electric machine in which torque is produced by the tendency of the movable part of the machine to move into a position where the inductance of an excited winding is maximized. An SRM is a type of a reluctance machine where the windings are energized as a function of the position of the movable part of the machine.

Conventional SRMs typically include one stator and one rotor, where the stator includes windings on the stator teeth to generate an electromagnetic field and the rotor in the electromagnetic field has the tendency to align with the stator to achieve maximum inductance. The rotor rotates as long as the stator excitation switches successfully.

SRMs are used in variety of applications, due to their simple construction, robustness and low cost. However, in some applications, conventional SRMs may need to be derated to prevent temperature limits from being exceeded.

### SUMMARY

The following summary is intended to introduce the reader to various aspects of the detailed description, but not to define or delimit any invention.

In accordance with one aspect of this disclosure, there is provided a switched reluctance machine. The switched reluctance machine includes a rotor; and a stator disposed concentrically with the rotor, the stator having a plurality of stator teeth and a plurality of windings wound about the plurality of teeth, the plurality of windings including, for each phase of the switched reluctance machine, a first set of coils and a second set of coils. The first set of coils comprises first coils characterized by a first number of turns; and the second set of coils comprises second coils characterized by a second number of turns. The first number of turns is higher than the second number of turns.

In some embodiments, each first coil is connected in series with a second coil of a same phase.

In some embodiments, a current density of the first coils is higher than a current density of the second coils.

In some embodiments, the first coils comprise a lower number of strands than the second coils.

In some embodiments, a wire gauge of the first coils is higher than a wire gauge of the second coils.

In some embodiments, each of the stator comprises an odd number of teeth per phase.

In accordance with another aspect of this disclosure, there is provided a motorized micro-mobility system generating an airflow path when the motorized micro-mobility system is in operation, the airflow path forming a region of greater airflow and a region of lower airflow, the micro-mobility having a switched reluctance machine as described herein. The switched reluctance machine is oriented so that a portion of the switched reluctance machine having a greater number of first coils is nearest the region of greater airflow.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

Several embodiments will be described in detail with reference to the drawings, in which:

FIG. 1 shows a schematic diagram of a cross-sectional view of a conventional switched reluctance machine;

FIG. 2 shows a heat map of the temperature distribution of a conventional switched reluctance machine;

FIG. 3 shows a schematic diagram of cross-sectional view of a switched reluctance machine in accordance with an embodiment;

FIG. 4 shows a heatmap of the flux density distribution of the switched reluctance machine of FIG. 3, when only one phase is excited;

FIG. 5 shows a plot of the electromagnetic torque of the switched reluctance machine of FIG. 3 and of a conventional switched reluctance machine, when only one phase is excited;

FIG. 6 shows a plot of the phase flux linkage of the switched reluctance machine of FIG. 3 and of a conventional switched reluctance machine, when only one phase is excited;

FIG. 7 shows a heatmap of the flux density distribution of the switched reluctance machine of FIG. 3, when all phases are simultaneously excited;

FIG. 8 shows a plot of the electromagnetic torque of the switched reluctance machine of FIG. 3 and of a conventional switched reluctance machine, when all phases are excited;

FIG. 9 shows a plot of the phase flux linkage of the switched reluctance machine of FIG. 3 and of a conventional switched reluctance machine, when all phases are excited;

FIG. 10 shows a plot of the electromagnetic torque of the switched reluctance machine of FIG. 3 and of a conventional switched reluctance machine at 1250 revolutions per minute (RPM); and

FIG. 11 shows a schematic diagram of an application of the switched reluctance machine of FIG. 3.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

As used in this application, the singular forms “a”, “an” and “the” include plural references unless the content clearly dictates otherwise.

In embodiments comprising an “additional” or “second” component, the second component as used herein is physically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

A reluctance machine is an electric machine in which torque is produced by the tendency of the movable part of the machine to move into a position where the inductance of an excited winding is maximized. A switched reluctance machine (SRM) is a type of a reluctance machine where the windings are energized as a function of the position of the movable part of the machine. A SRM has salient poles on both the rotor and the stator.

Switched reluctance machines have a simple, low-cost, and robust construction. SRMs can operate without permanent magnets which have significant supply chain issues. Expanding the usability of switched reluctance machines may contribute to lower cost, reliable, high-performance machines for various applications without the supply chain risks inherent in machines requiring permanent magnets. SRMs can additionally operate at high temperatures and speeds.

Switched reluctance machines can be used in a variety of applications, including in micro-mobility applications, such as electric bicycles, electric scooters and electric motorcycles. SRMs are often used in these applications, due to their low-cost and robust construction.

Conventional SRMs are often cooled to improve their performance and prevent the temperature limits of the components of the SRM or of the SRM themselves from being exceeded. In many applications, cooling is applied unidirectionally, or in an otherwise uneven manner, causing the SRM to be unevenly cooled. Uneven cooling can often prevent an SRM from operating at full capacity, since the capacity may be limited by the hotter sections of the SRM (i.e., the sections receiving less cooling).

The embodiments described herein provide a switched reluctance machine with asymmetric loss distribution. The described embodiments can be used in a variety of applications and particularly in applications where uneven cooling is applied. The asymmetric loss distribution of the described embodiments can allow an SRM to be evenly cooled even when uneven cooling is applied. The described embodiments can result in SRMs with improved performance that may operate at full capacity.

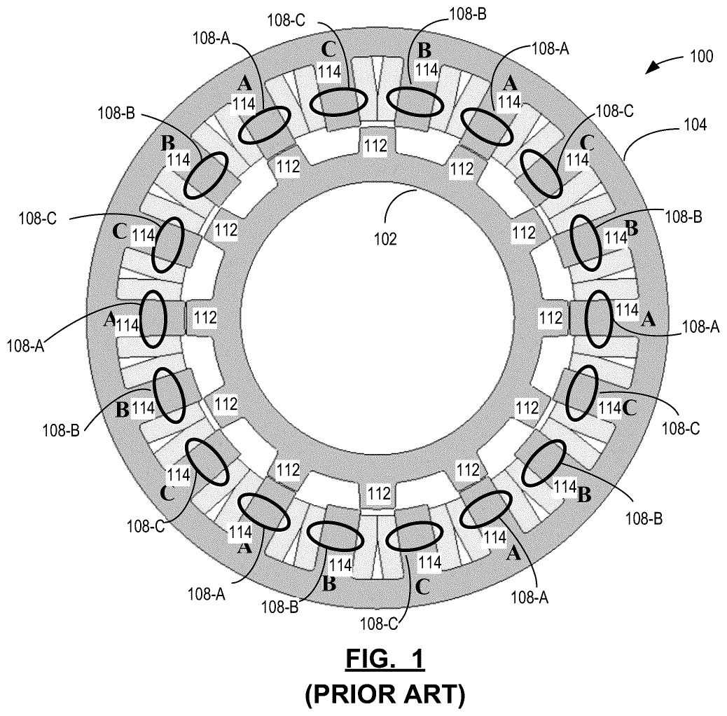

Referring first to FIG. 1, there is shown a schematic diagram of a cross-section of a conventional three-phase switched reluctance machine 100. SRM 100 is an example of a switched reluctance machine having a rotor 102 and a stator 104. As shown, the rotor 102 and the stator 104 are disposed concentrically and coaxially with one another. In the SRM 100, the rotor 104 is positioned radially inward of the stator 102.

The stator 104 has 18 stator poles 114 and windings 108 wound around the stator teeth of the stator poles 114. The windings include coils 108 that are wound around each stator tooth of the stator pole 114 and connected together to create the phase windings for each phase. In SRM 100, the coils 108 on diametrically opposite stator pole pairs are connected in series or in parallel to form a phase of the machine. Each coil 108 has the same construction (i.e., same number of turns, same number of strands, same wire gauge) and the SRM 100 has a uniform loss distribution. Although FIG. 1 shows an SRM with 18 stator poles 114, 12 rotor poles 112 and 3 phases, SRMs may be designed with varying numbers of stator and rotor poles, and varying number of phases. In general, SRMs typically do not include excitation sources on the rotor 102. The SRM 100 can operate in the manner known to those skilled in the art.

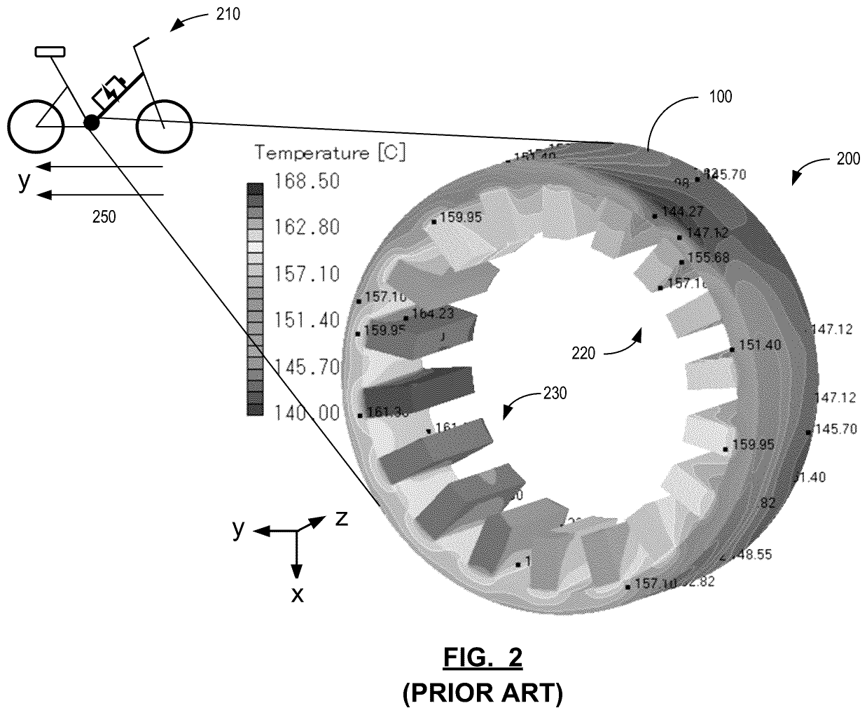

Referring to FIG. 2, there is shown an application of the SRM 100 in an electric bicycle 210. SRMs are typically used in micro-mobility applications due to their robustness, simple construction and low cost. A heat map 200 of the SRM 100 showing the temperature distribution of the SRM 100 when used in the electric bicycle 210 is also provided.

When the electric bike 210 is in motion, air generated by the electric bicycle's 210 motion flows in the illustrated direction y 250, cooling the SRM 100. However, due to the placement of the SRM 100 on the electric bicycle 210 relative to the airflow, one side of the SRM 100 is typically more exposed to airflow, and is therefore cooled more effectively. As shown in the heatmap 200, air cools the portion of the SRM 100 that is closest to the airflow more efficiently (portion 220) while the portion of the SRM 100 that faces away from the airflow is cooled less efficiently (portion 230), resulting in uneven temperature distribution inside the SRM 100 and resulting in one side of the SRM 100 having a higher temperature (portion 230) than the other (portion 220). This uneven distribution of temperature can cause the SRM 100 to derate to prevent the temperature limits of the side of the SRM 100 having a higher temperature (portion 230) from being exceeded, causing the SRM 100 to operate under capacity.

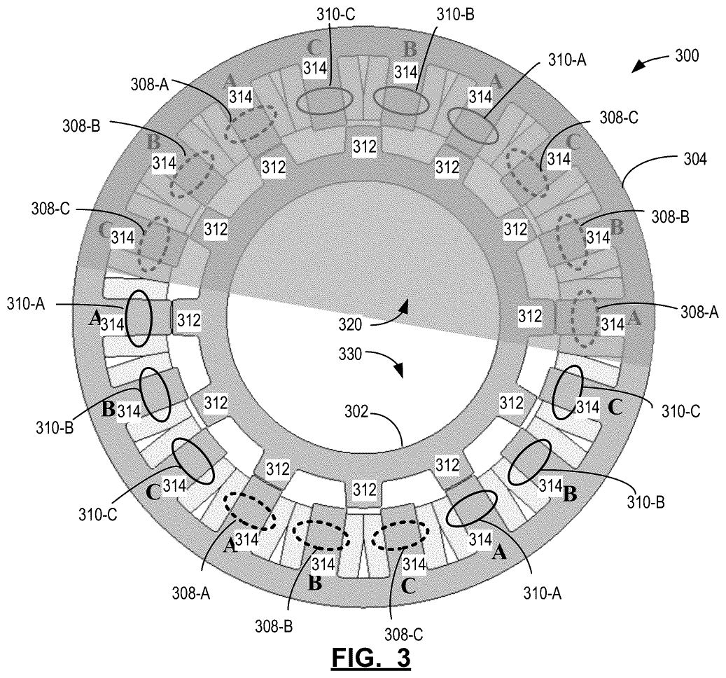

Referring now to FIG. 3, there is shown a schematic diagram of a cross-section of a switched reluctance machine 300 in accordance with an embodiment. When compared to SRM 100, SRM 300 can operate at a higher capacity, by reducing SRM derating. Similar to SRM 100, the switched reluctance machine 300 has a rotor 302 and a stator 304. As shown, the rotor 302 and the stator 304 are disposed concentrically and coaxially with one another and the rotor 302 is positioned radially inward of the stator 304. Although the switched reluctance machine 300 is a three-phase SRM, the switched reluctance machine 300 can have any number of phases. Further, although the SRM 300 has 18 stator poles 314 and 12 rotor poles 312, the SRM 300 can have other configurations. The SRM 300 can have an odd number of stator poles 314 per phase, per half motor section. For example, as shown in FIG. 3, the SRM 300 can have a total of 9 stator poles 314 per half motor section resulting in 3 stator poles 314 per phase, per half motor section.

The SRM 300 can operate in the same manner as conventional SRMs, as is known to those skilled in the art. The SRM 300 can generally include similar components to the components of SRM 100 and can operate in a similar manner as SRM 100. However, unlike SRM 100, SRM 300 includes windings that include two sets of coils 308, 310 having different constructions. The coils belonging to the first set of coils 308 can have a higher number of turns than the coils belonging to second set of coils 310. The coils belonging to the first set of coils 308 can be referred to as hot coils since, as will be explained in further detail below, the higher number of turns causes more heat to be dissipated when current flows through the coils, relative to the coils belonging to the second set of coils 310. The coils belonging to the second set of coils 310 can be referred to as warm coils since the lower number of turns relative to the first set of coils 308 causes less heat to be dissipated when current flows through the coils, relative to the coils belonging to the first set of coils 308.

In at least one embodiment, the hot coils 308 have a lower number of strands than the warm coils 310. The number of strands of the hot coils 308 can be lower relative to the warm coils 310 so that the height of the hot coils 308 and the warm coils 310 can be similar even if the hot coils 308 have a higher number of turns relative to the warm coils 310.

In at least one embodiment, the hot coils 308 have a higher wire gauge than the warm coils 310. The wire gauge of the hot coils 308 can be higher than the wire gauge of the warm coils 310 so that the height of the hot coils 308 and the warm coils 310 can be similar even if the hot coils 308 have a higher number of turns relative to the warm coils 310.

In at least one embodiment, the coils belonging to the first set of coils 308 have a higher current density than the coils belonging to the second set of coils 310. The higher current density can be caused by a lower number of strands and/or a higher wire gauge.

Each hot coil 308 can be connected in series to a warm coil 310 of the same phase. Connecting hot coils 308 in series with warm coils 310 of the same phase allows the electromagnetic balance of the SRM 300 to be maintained and allows the SRM 300 to maintain a flux linkage that is similar to the flux linkage of a conventional SRM.

The configuration of hot coils and warm coils results in one half of the SRM being warmer (i.e., the side having more hot coils) than the other half, when the SRM is in operation. As shown in FIG. 3, side 320 is the hot side, since it includes a higher number of hot coils 308 and side 330 is the warm side, since it includes a higher number of warm coils 310.

Since the coils 308 and 310 have different constructions, the coils 308, 310 can have different copper losses, that is, the heat produced by the current flowing in the coils 308, 310 can differ. As is generally known to those skilled in the art, when current is flowing through the coils 308, 310, some of the energy is lost in the form of heat in the material of the windings, the stator 304 and/or rotor 302 via copper losses and iron losses. The hot coils 308, which have a higher number of turns and may have a lower number of strands and/or a higher wire gauge can have a higher resistance and accordingly more heat is dissipated by the hot coils 308 than the warm coils 310 (i.e., the hot coils 308 have larger copper losses). The hot coils 308 also generate higher flux density levels at the teeth of the stator poles 314 around which the coils 308 are wound, increasing the iron losses at those stator poles 314, as iron losses increase with flux density. The larger copper and iron losses results in the hot coils 308 generating more heat than the warm coils 310.

By contrast, the warm coils 310, which have a lower number of turns and may have a lower number of strands and/or a higher wire gauge, can have a lower resistance and accordingly, smaller copper losses. The warm coils 310 also generate lower flux density levels at the teeth of the stator poles 314 around which the coils 310 are wound, resulting in lower iron losses at those stator poles 314 when compared to the stator poles about whose teeth the hot coils 308 are wound.

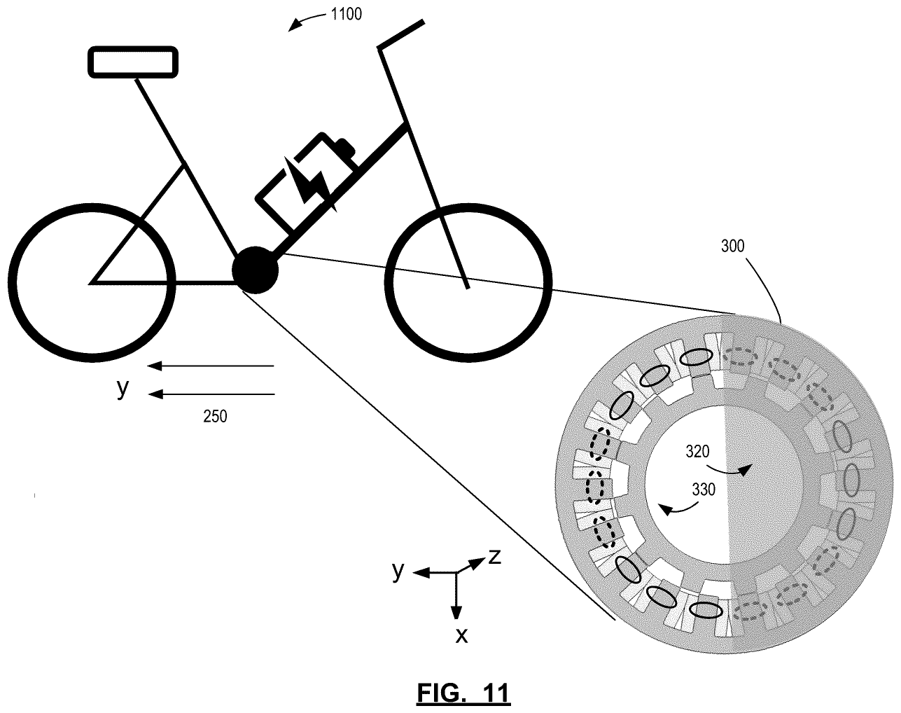

The differential between the losses at the teeth of the stator poles 314 around which hot coils 308 are wound and the teeth of the stator poles 314 around which warm coils 310 are wound results in asymmetric loss distribution inside the SRM 300. This asymmetric loss distribution can be desirable in applications where the SRM is unevenly cooled, as will be explained in further detail with reference to FIG. 11.

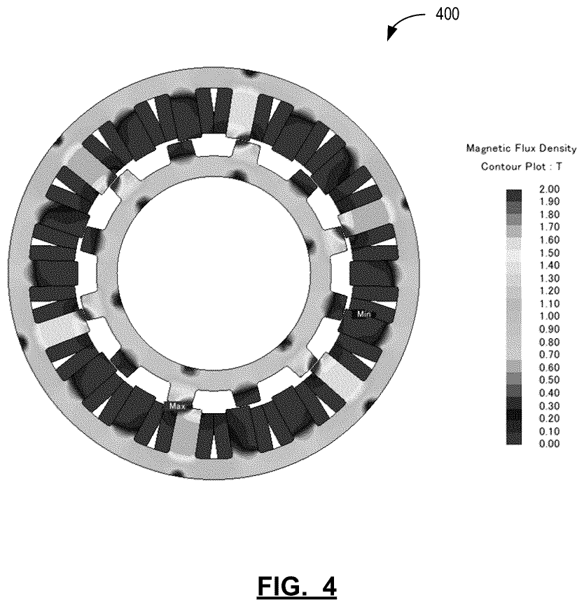

Reference is made to FIG. 4, which shows a heatmap 400 of the flux density distribution of SRM 300 when one phase is excited. As shown, the flux density is evenly distributed, despite not all coils sharing the same construction.

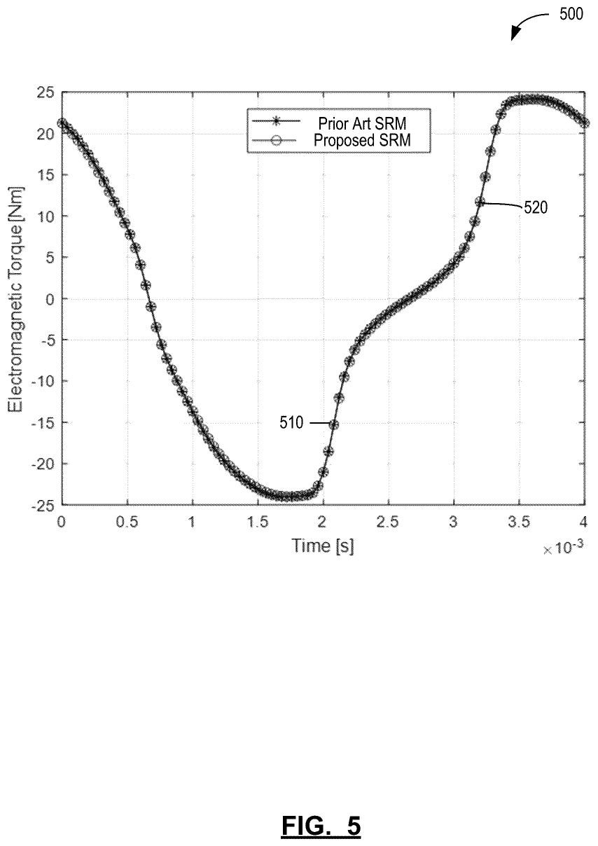

Reference is next made to FIG. 5, which shows a plot 500 of the electromagnetic torque of SRM 300 (line 510) and of a conventional switched reluctance machine (line 520), such as SRM 100, when only one phase is excited. As shown, the electromagnetic torque of SRM 300 is similar to the electromagnetic torque of a conventional SRM.

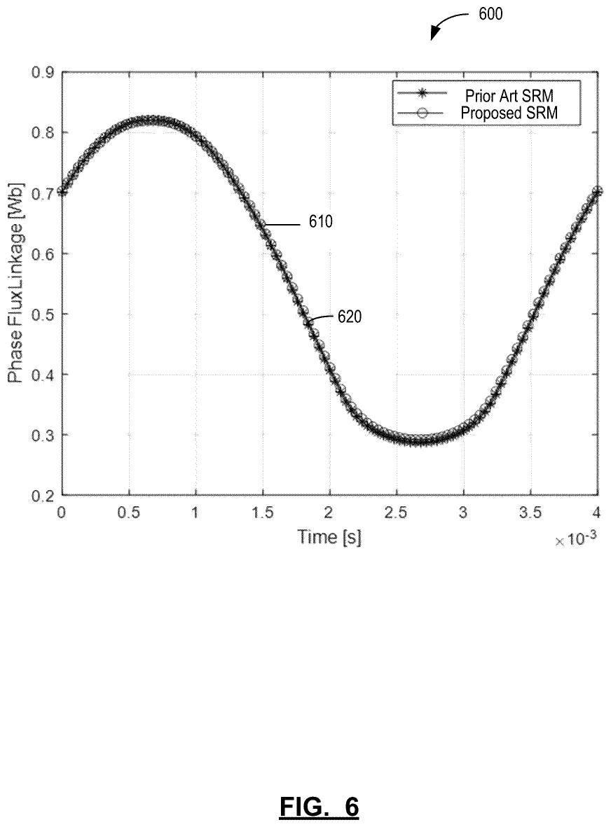

Reference is also made to FIG. 6, which shows a plot 600 of the phase flux linkage of the SRM 300 (line 610) and of a conventional SRM such as SRM 100 (line 620), when only one phase is excited. As shown, the flux linkage of the SRM 300 is similar to the flux linkage of a conventional SRM.

As shown in FIGS. 5 and 6, the SRM 300 has a similar torque capability and phase flux linkage as a conventional SRM when one phase is excited.

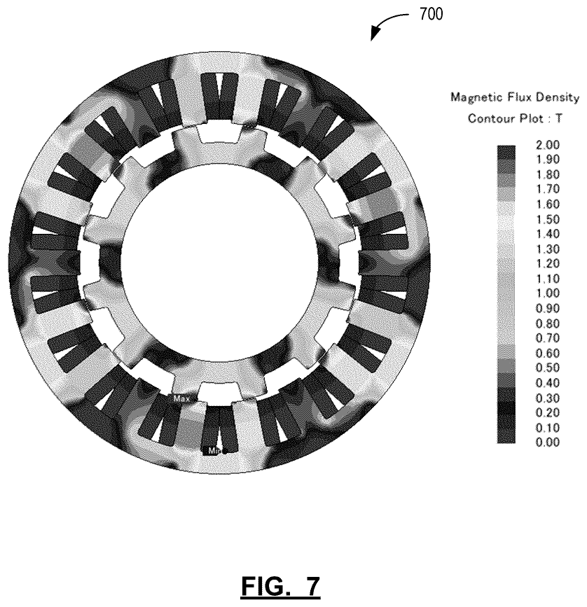

Reference is made to FIG. 7, which shows a heatmap 700 of the flux density distribution of SRM 300 when all three phases are excited. As shown, the flux density is evenly distributed, despite not all coils sharing the same construction.

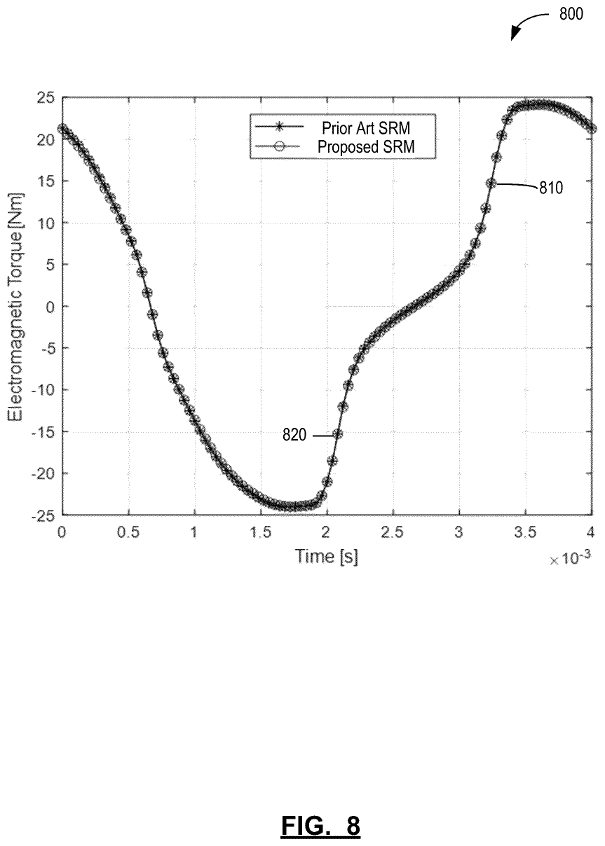

Reference is made to FIG. 8, which shows a plot 800 of the electromagnetic torque of SRM 300 (line 810) and of a conventional switched reluctance machine (line 820), such as SRM 100, when all phases of the SRM 300 are excited. The phases are excited with different constant currents. As shown, the flux linkage of the SRM 300 is similar to the flux linkage of a conventional SRM.

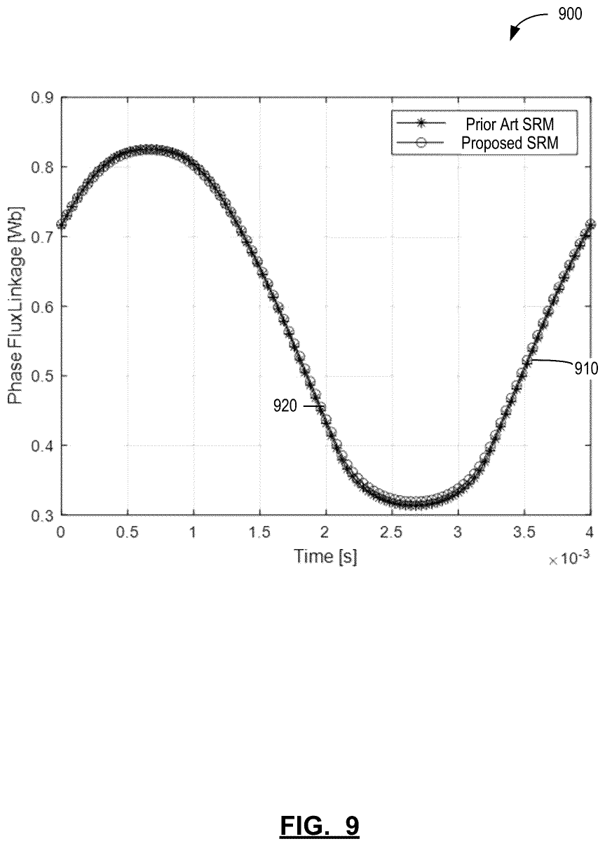

Reference is also made to FIG. 9, which shows a plot 900 of the phase flux linkage of the SRM 300 (line 910) and of a conventional SRM such as SRM 100 (line 920), when all phases of the SRM are excited. As shown, the flux linkage of the SRM 300 is similar to the flux linkage of a conventional SRM.

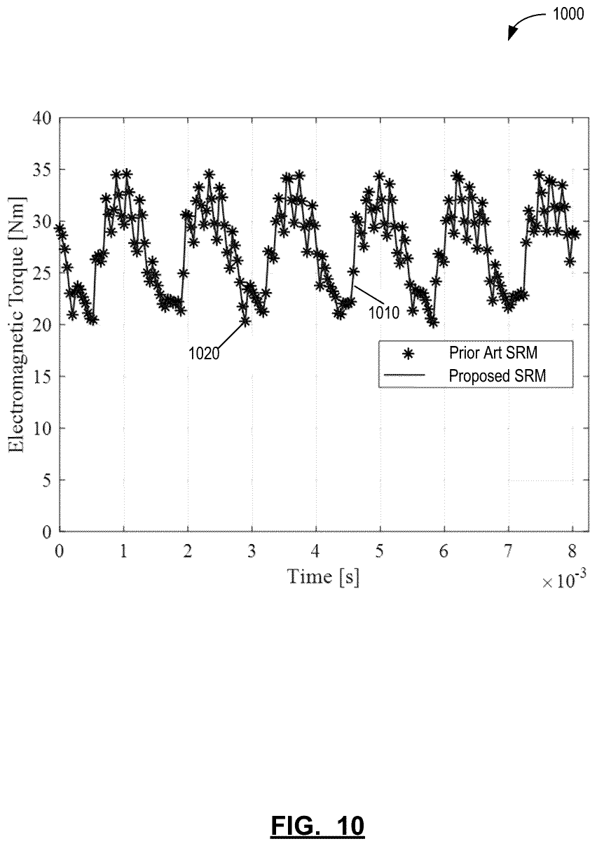

Reference is made to FIG. 10, which shows a plot 1000 of the electromagnetic torque of the SRM 300 (line 1010) and of a conventional switched reluctance machine (line 1020), such as SRM 100 when the SRMs are operating at 1250 revolutions per minute (RPM). As shown, the electromagnetic torque of the SRM 300 is similar to the electromagnetic torque of a conventional SRM.

As shown in FIGS. 5-10, the electromagnetic torque and the flux linkage of the SRM 300 are similar to those of a conventional SRM, indicating that under the same conditions, the performance of SRM 300 is similar to that of a conventional SRM. Accordingly, the SRM 300 can be used in similar applications as a conventional SRM.

Referring now to FIG. 11, there is shown an application of the switched reluctance machine described herein. As shown, the switched reluctance machine 300, similar to the SRM 100 can be used in an electric bicycle 1100. Though an electric bicycle 1100 is shown, the switched reluctance machine 300 can be used in any other system that is unidirectionally cooled, including, but not limited to, other micro-mobility systems (e.g., electric scooters, electric motorcycles).

The SRM 300 can be positioned in the electric bicycle 1100 in a position that allows the hot side 320 of the SRM 300 to be orientated toward the direction of airflow 250. As explained with reference to FIG. 2, SRMs, when used in electric bicycles 1100 are typically cooled through natural convection, by the airflow generated by the electric bicycle's 1100 motion. The region of the SRM that is closest to the airflow therefore receives more air and is cooled more effectively than the region located away from the airflow.

Since the coil construction of the SRM 300 results in an asymmetric loss distribution and in one half of the SRM 300 being hotter than the other, by orienting the hot side 320 toward the direction of the airflow 350, the SRM 300 can take advantage of the uneven airflow. The hot side 320, which requires more cooling relative to the warm side 315 therefore receives more airflow and can be cooled more than the warm side, which requires less cooling, resulting in an evenly cooled SRM 300.

Since the SRM 300 can be evenly cooled, the temperature distribution of the SRM 300 can be more uniform compared to the temperature distribution of SRM 100 shown in FIG. 2, which can reduce derating caused by preventing the temperature limits of the SRM 300 from being exceeded. The full capacity of the SRM 300 may therefore be utilized.

While the present application has been described with reference to examples, it is to be understood that the scope of the claims should not be limited by the embodiments set forth in the examples, but should be given the broadest interpretation consistent with the description as a whole.

1. A switched reluctance machine comprising:
a rotor; and
a stator disposed concentrically with the rotor, the stator having a plurality of stator teeth and a plurality of windings wound about the plurality of teeth, the plurality of windings including, for each phase of the switched reluctance machine, a first set of coils and a second set of coils,
the first set of coils comprising first coils characterized by a first number of turns; and
the second set of coils comprising second coils characterized by a second number of turns,
wherein the first number of turns is higher than the second number of turns.

2. The switched reluctance machine of claim 1, wherein each first coil is connected in series with a second coil of a same phase.

3. The switched reluctance machine of claim 1, wherein a current density of the first coils is higher than a current density of the second coils.

4. The switched reluctance machine of claim 1, wherein the first coils comprise a lower number of strands than the second coils.

5. The switched reluctance machine of claim 1, wherein a wire gauge of the first coils is higher than a wire gauge of the second coils.

6. The switched reluctance machine of claim 1, wherein each of the stator comprises an odd number of teeth per phase.

7. A motorized micro-mobility system generating an airflow path when the motorized micro-mobility system is in operation, the airflow path forming a region of greater airflow and a region of lower airflow, the micro-mobility having a switched reluctance machine according to claim 1, wherein the switched reluctance machine is oriented so that a portion of the switched reluctance machine having a greater number of first coils is nearest the region of greater airflow.
